(19) United States
(12) Patent Application Publication
(10) Pub. No.: US 2018/0306901 A1
(43) Pub. Date: Oct. 25, 2018

(54) RADAR SYSTEM AND METHOD WITH AUXILIARY CHANNEL FOR INTERFERENCE DETECTION

(71) Applicant: QAMCOM TECHNOLOGY AB, Gothenburg (SE)

(72) Inventors: Thomas PERNSTÅL, Åsa (SE); Gary SMITH JONFORSEN, Askim (SE)

(21) Appl. No.: 15/769,899

(22) PCT Filed: Oct. 17, 2016
(86) PCT No.: PCT/SE2016/051000

§ 371 Date: Apr. 20, 2018

(30) Foreign Application Priority Data
Oct. 20, 2015 (SE) 1530161-7

(51) Int. Cl. G01S 7/02; G01S 13/88; G01S 13/93; G01S 7/03; G01S 13/91

(52) U.S. Cl. CPC G01S 7/021; G01S 13/883; G01S 13/931; G01S 2013/9328; G01S 7/03; G01S 13/91; G01S 7/023

(57) ABSTRACT

A radar system for monitoring a region of interest including a receiving antenna arrangement for receiving signals from a region of interest and a receiver signal processing arrangement for processing received signals. The radar system further includes at an auxiliary channel antenna arrangement for receiving signals from at least the region of interest and with a sensing characteristic for received signals which is mutually different to that of the receiving antenna arrangement. The receiver signal processing arrangement is operable to process the received signals from the receiving antenna arrangement and the auxiliary channel antenna arrangement to discriminate a jamming and/or interfering source in or near the region of interest.

### TECHNICAL FIELD

The present disclosure relates to radar system, for example to radar systems that are operable to emit and receive electromagnetic radiation at a frequency of substantially 77 GHz for interrogating a spatial region of interest (ROI). Moreover, the present disclosure concerns methods of operating aforesaid radar system, for example to enable aforesaid system to distinguish more effectively between desired and interfering signals. Furthermore, the present disclosure is concerned with computer program products comprising a non-transitory computer-readable storage medium having computer-readable instructions stored thereon, the computer-readable instructions being executable by a computerized device comprising processing hardware to execute aforesaid methods.

### BACKGROUND

In overview, radar systems are well known and an example radar system includes an emitting antenna arrangement for emitting electromagnetic radiation towards a region of interest (ROI) and a receiving antenna arrangement for receiving a portion of the emitted electromagnetic radiation that is reflected back from the region of interest (ROI). On account of the emitting antenna arrangement and/or the receiving antenna arrangement having polar characteristics having directions of greater gain, the radar system is capable of mapping out the region of interest (ROI). Moreover, time-of-flight and Doppler frequency shift information included in the portion of the emitted electromagnetic radiation that is reflected back from the region of interest (ROI) enables one of more objects in the region of interest (ROI) to be monitored, for example as in Doppler radar systems for selectively measuring speeds of road vehicles.

In a United Kingdom patent application GB 2498564 A, “Level-crossing protection system which sends a warning to an approaching train via GSM-R network” (inventors—Jones et al., applicant Siemens plc), there is described a rail crossing system for detecting major obstructions on un-manned rail crossings and sending information to approaching trains to warn them of such obstructions. The rail crossing system includes means for detecting an obstacle on a rail crossing and a radio communication network for sending information to a train approaching the rail crossing. The radio communication network is described to be based on GSM (for example, Global System for Mobile Communications-Railway (GSM-R) network), namely the information may be sent using a protocol based on the GSM-R standard, for example as an Emergency Group Call message. The rail crossing system described in the United Kingdom patent application GB 2498564 A provides that a warning message, sent to the train to notify the train driver and/or on-board train control system of a detected obstruction on the rail crossing, is received without much delay which might otherwise be caused by the involvement of other network components and/or rail signalling infrastructure. Optionally, the rail crossing system also includes a detector fault monitoring means that assumes the detector to be faulty, if detector activation has not been seen, namely evident, for a configured time. In such a manner, the rail crossing system is susceptible to being configured to take an action, such as, from simply logging the fault, through to sending a voice message warning approaching trains that the system is not functioning properly.

Research and development undertaken by Siemens plc in respect of the aforementioned rail crossing protection system has resulted in a proprietary Heimdall family of radar detectors being developed. The Heimdall family of radar detectors is used for applications in traffic and pedestrian management. Every detector includes a planar radar antenna system and a digital signal processing engine. The Heimdall family of radar detectors uses 24 GHz radar technology. Being based on radar technology, the detectors provide certain advantages over vision-based detection systems that are potentially strongly compromised by extreme lighting conditions, fog, rain, and so forth. Optionally, the detector is fitted with a dedicated detector fault output, as required. For on-crossing applications, the detectors have a range of up to 12 metres and crossing width typically up to 4 metres when used as a pair.

In a European patent application EP 0403 954 A2, “Clear track signalling device for railways”, inventors—Pieverling and Ritter; applicant—Siemens AG), there is described a device for track vacancy detection in a rail sector. The device uses two transceiver antennae, wherein a first transceiver antenna is directed vertically and a second transceiver antenna is directed obliquely towards a train to be evaluated. Echo signals picked up by the first transceiver antenna determine a beginning and an end of the train, and echo signals from the second transceiver antenna determine a respective train speed, and these output values are susceptible to being used to determine a length of the train. In such a manner, the device determines by comparing the determined length of the train to a predetermined length, whether or not the train has left a given track section. Moreover, the device has been described to use discriminators along with the two transceiver antennae to evaluate the train, only if it has been passing at a certain distance to avoid parallel measurement uncertainties that may affect the safety of track vacancy detection that is thereby provided by the device when in operation.

In a published United States patent application U.S. Pat. No. 4,096,480A (Inventors: Mark S. Miner, Charles W. Crickman) (Applicant: The United States Of America As Represented By The Secretary Of The Army), there is described a decision circuit for a proximity fuze. The decision circuit comprises:
(i) a first antenna connected to a first receiver channel, wherein the first antenna has a polar response pattern having a main beam and a plurality of side lobes;
(ii) a second antenna connected to a second receiver channel, wherein the second antenna has a polar response pattern having a broad beam and a gain of less than the main beam but greater than the gain of the side lobes of the first antenna;
(iii) a first range gated arrangement in the first receiver channel for detecting and amplifying a valid target return signal;
(iv) a second range gated arrangement in the first receiver channel for detecting and amplifying target signals arriving at a time other than the valid target return signal, wherein the second range gated arrangement has a higher gain that the first range gated arrangement;
(v) a first comparison arrangement for producing a signal when the output of the first range gated arrangement exceeds the output of the second range gated arrangement;
(vi) a third range gated arrangement in the second receiver channel for detecting and amplifying signals arriving in the same time period as signals received by the second range gated arrangement; and
(vii) a second comparison arrangement for producing a signal when an output from the second range gated arrangement taken at a lower gain point than the output compared with the output of the first range dated arrangement exceeds the output from the third range gated arrangement by a pre-determined difference.

In a published United States patent U.S. Pat. No. 4,044,359A (Inventors: Sidney P. Applebaum, Paul W. Howells, James C. Kovarik) (Applicant: General Electric Company), there is described a canceller for removing an undesired signal, a main signal transmission channel having an output terminal, a plurality of auxiliary signal transmission channels having output terminals, means for cross coupling each of the auxiliary channels separately to the main signal transmission channel, means for generating error signals representing the relative amplitude and phase of each undesired signal in the auxiliary channels cross-coupled with undesired signals in the main channel, compensating cross feed networks capable of adjustment for minimizing cross coupling at the main channel output terminal, and means responsive to the error signals for adjusting the cross feed networks in order to minimize cross coupling.

In a published United States patent application US 20110034141A1 (Inventor: Peter Alan Langsford) (Applicant: BAE Systems Plc), there is described a process for minimising jammer noise in receiver systems. The process utilizes a primary receiver and a plurality of secondary receivers for receiving signals. Moreover, the process also includes steps of:
(i) separately correlating the signals; and
(ii) determining a magnitude of the correlation between signals and minimising jammer noise in the signals.

In a published United States patent U.S. Pat. No. 4,573,052 (Inventors: Jean C. Guillerot, Hubert Joncour, Gerard Auvray, Daniel Balduzzi) (Applicant: Thomson CSF), there is described a method of reducing a power of jamming signals received by side-lobes of a radar antenna with which auxiliary antennas are associated, wherein the method includes forming a linear weighted combination of complex signals delivered by the auxiliary channels that is subtracted from a signal of a main channel of a radar antenna.

It is known in radar systems that jamming signals can arise when the radar systems are in operation. Such jamming is potentially both intentional and arising spontaneously in an unintended manner. For example, for a radar system monitoring a railway level-crossing, it is potentially feasible for vehicle-mounted radar systems, for example radar-based automatic braking and/or steering systems, to emit in operation electromagnetic radiation signals that can interfere with a radar system that is arranged to monitor whether or not a given railway level-crossing is free from obstacles that could potentially cause a hazardous situation to arise. In a United States patent U.S. Pat. No. 4,891,647 A, there is described a method and a device for reducing a power of jamming signals received by a main antenna of a radar that is operable to transmit at a random frequency; the radar has associated therewith a number of secondary antennas. A weighted linear combination of the signals delivered by the processing channels of the main and secondary antennae is made and weighting coefficients relative to a next transmission frequency are determined, and this is subtracted from the main channel signal in order to reduce the resulting jamming power in the main channel.

Thus, in practice, there arises a technical problem of how to make radar systems, for example for monitoring obstacles at railway level-crossings, less susceptible to jamming and/or false detection of obstacles, as aforementioned. It is desirable that the radar system is not compromised by radar interference or jamming, such jamming and/or false detection can potentially arise from a vehicle-mounted radar apparatus, for example an anti-crash automatic braking system of the vehicle operating at same electromagnetic radiation emission frequency as of the radar system, for example substantially 24 GHz or substantially 77 GHz. Otherwise there is risk that the radar system is unable to detect correctly a presence of one or more objects, for example an obstacle which could pose a danger to a passing train when barriers of the aforesaid railway level-crossing are in a closed state to prevent road traffic or passengers traversing the level-crossing. Similar considerations also pertain to road vehicle and passenger safety at the aforementioned railway level-crossing, so that a train driver is warned in advance by the radar system of a potential hazard ahead of the train.

### SUMMARY

The present disclosure seeks to provide an improved radar system that is less susceptible to jamming and/or interference, for example at a railway level-crossing environment.

Moreover, the present disclosure seeks to provide an improved method of operating a radar system that is less susceptible to jamming and/or interference, for example at a railway level-crossing environment.

According to a first aspect, there is provided a radar system for monitoring a region of interest (ROI), wherein the radar system includes a transmitter signal processing arrangement for generating signals for an emitting antenna arrangement to emit as electromagnetic radar radiation to the region of interest (ROI), wherein the transmitter signal processing arrangement is operable to employ frequency hopping in operation, and a receiving antenna arrangement for receiving reflected electromagnetic radar radiation from the region of interest (ROI) and a receiver signal processing arrangement for processing received signals corresponding to the reflected electromagnetic radar radiation from one or more objects in the region of interest (ROI), characterized in that:
(i) the radar system includes at least one auxiliary channel antenna arrangement for receiving signals from at least the region of interest (ROI), wherein the auxiliary channel antenna arrangement and the receiving antenna arrangement are mounted such that their axes are offset by an non-zero angle, and wherein the at least one auxiliary channel antenna arrangement has a sensing characteristic which is mutually different to that of the receiving antenna arrangement; and
(ii) the receiver signal processing arrangement is operable to process the received signals from the receiving antenna arrangement and from the at least one auxiliary channel antenna arrangement, and to discriminate therefrom one or more signals corresponding to a jamming and/or an interfering source in or near the region of interest (ROI) from the received signals from the receiving antenna arrangement.

The aspects of the present disclosure are of advantage in that different relative responses of the receiving antenna arrangement and the at least one auxiliary channel antenna arrangement enables potentially interfering sources of radiation to be discriminated from reflected signals arising from objects within the region of interest (ROI).

Optionally, in the radar system, the transmitter signal processing arrangement, for generating signals to be emitted in operation as corresponding electromagnetic radar radiation from the emitting antenna arrangement, is operable to generate chirp signals when in operation. More optionally, in the radar system, the chirp signals, to be emitted in operation as corresponding electromagnetic radar radiation from the emitting antenna arrangement, are chirped in a range of 100 MHz to 500 MHz, and more optionally substantially 300 MHz.

More optionally, the radar system is operable to vary a centre frequency of the chirp signals. More optionally, the radar system is operable to vary the centre frequency of the chirp signals in at least one of following temporally-varying frequency patterns:
(a) a pre-determined manner;
(b) a frequency swept manner; and
(c) an adaptive manner, wherein the centre frequency is varied depending upon a degree of interference suppression exhibited by the radar system.

Optionally, in the radar system, the transmitter signal processing arrangement for generating signals to be emitted in operation as corresponding electromagnetic radar radiation from the emitting antenna arrangement is operable to employ temporally pseudo-random frequency hopping in operation.

Optionally, in the radar system, the emitting antenna arrangement is operable to emit the electromagnetic radar radiation in a range of 10 GHz to 200 GHz, and more optionally at substantially 24 GHz or substantially 77 GHz.

According to a second aspect, there is provided a method of using a radar system for monitoring a region of interest (ROI), wherein the radar system includes a transmitter signal processing arrangement for generating signals to be emitted in operation as corresponding electromagnetic radar radiation from an emitting antenna arrangement to the region of interest (ROI), wherein the transmitter signal processing arrangement is operable to employ frequency hopping in operation, and a receiving antenna arrangement for receiving reflected electromagnetic radar radiation from the region of interest (ROI) and a receiver signal processing arrangement for processing received signals corresponding to the reflected electromagnetic radar radiation from one or more objects in the region of interest (ROI), characterized in that the method includes:
(i) arranging for the radar system to include at least one auxiliary channel antenna arrangement for receiving signals from at least the region of interest (ROI), wherein the auxiliary channel antenna arrangement and the receiving antenna arrangement are mounted such that their axes are offset by an non-zero angle, and wherein the at least one auxiliary channel antenna arrangement has a sensing characteristic which is mutually different to that of the receiving antenna arrangement; and
(ii) operating the receiver signal processing arrangement to process the received signals from the receiving antenna arrangement and from the at least one auxiliary channel antenna arrangement and to discriminate therefrom one or more signals corresponding to a jamming and/or an interfering source in or near the region of interest (ROI) from the received signals from the receiving antenna arrangement.

Optionally, the method includes arranging for the transmitter signal processing arrangement for generating signals, to be emitted in operation as corresponding electromagnetic radar radiation from the emitting antenna arrangement, to be operable to generate chirp signal in operation. More optionally, the method includes arranging for the signals, to be emitted in operation as corresponding electromagnetic radar radiation from the emitting antenna arrangement, to be chirped in a range of 100 MHz to 500 MHz, and more optionally substantially 300 MHz.

Optionally, the method includes operating the radar system to vary a centre frequency of the chirp signals. More optionally, the method includes operating the radar system to vary the centre frequency of the chirp signals in at least one of following temporally-varying frequency patterns:
(a) a pre-determined manner;
(b) a frequency swept manner; and
(c) an adaptive manner, wherein the centre frequency is varied depending upon a degree of interference suppression exhibited by the radar system.

Optionally, the method includes arranging for the transmitter signal processing arrangement for generating signals, to be emitted in operation as corresponding electromagnetic radar radiation from the emitting antenna arrangement, to be operable to employ temporally pseudo-random frequency hopping in operation.

Optionally, he method includes arranging for the emitting antenna arrangement to be operable to emit the electromagnetic radar radiation in a range of 10 GHz to 200 GHz, and more optionally at substantially 24 GHz or substantially 77 GHz.

According to a third aspect, there is provided a method of using a radar system for monitoring a region of interest (ROI), wherein the radar system includes an emitting antenna arrangement for emitting electromagnetic radar radiation to the region of interest (ROI) and a transmitter signal processing arrangement for generating signals to be emitted in operation as corresponding electromagnetic radar radiation from the emitting antenna arrangement, and a receiving antenna arrangement for receiving reflected electromagnetic radar radiation from the region of interest (ROI), and a receiver signal processing arrangement for processing received signals corresponding to the reflected electromagnetic radar radiation from one or more objects in the region of interest (ROI), characterized in that the method includes:
(i) arranging for the radar system to include at least one auxiliary channel antenna arrangement for receiving signals from at least the region of interest (ROI), wherein the at least one auxiliary channel antenna arrangement has a sensing characteristic which is mutually different to that of the receiving antenna arrangement; and
(ii) operating the receiver signal processing arrangement to process the received signals from the receiving antenna arrangement and from the at least one auxiliary channel antenna arrangement and to discriminate therefrom one or more signals corresponding to a jamming and/or an interfering source in or near the region of interest (ROI) from the received signals from the receiving antenna arrangement.

Optionally, the method includes arranging for the transmitter signal processing arrangement for generating signals, to be emitted in operation as corresponding electromagnetic radar radiation from the emitting antenna arrangement, to be operable to generate chirp signal in operation.

Optionally, the method includes arranging for the signals, to be emitted in operation as corresponding electromagnetic radar radiation, from the emitting antenna arrangement, to be chirped in a range of 1 MHz to 1000 Hz, more optionally in a range of 100 MHz to 500 MHz, and yet more optionally substantially 300 MHz.

Optionally, the method includes arranging for the transmitter signal processing arrangement for generating signals, to be emitted in operation as corresponding electromagnetic radar radiation from the emitting antenna arrangement, to be operable to employ temporally pseudo-random frequency hopping in operation.

Optionally, the method includes arranging for the emitting antenna arrangement to be operable to emit the electromagnetic radar radiation in a range of 10 GHz to 200 GHz and more optionally at substantially 24 GHz or substantially 77 GHz.

Optionally, the method includes monitoring one or more obstacles present within the region of interest (ROI), when the region of interest is a pedestrian crossing and/or a railway level-crossing environment.

According to a fourth aspect, there is provided a computer program product comprising a non-transitory computer-readable storage medium having computer-readable instructions stored thereon, the computer-readable instructions being executable by a computerized device comprising processing hardware to execute aforesaid methods of the disclosure.

It will be appreciated that features of the invention are susceptible to being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

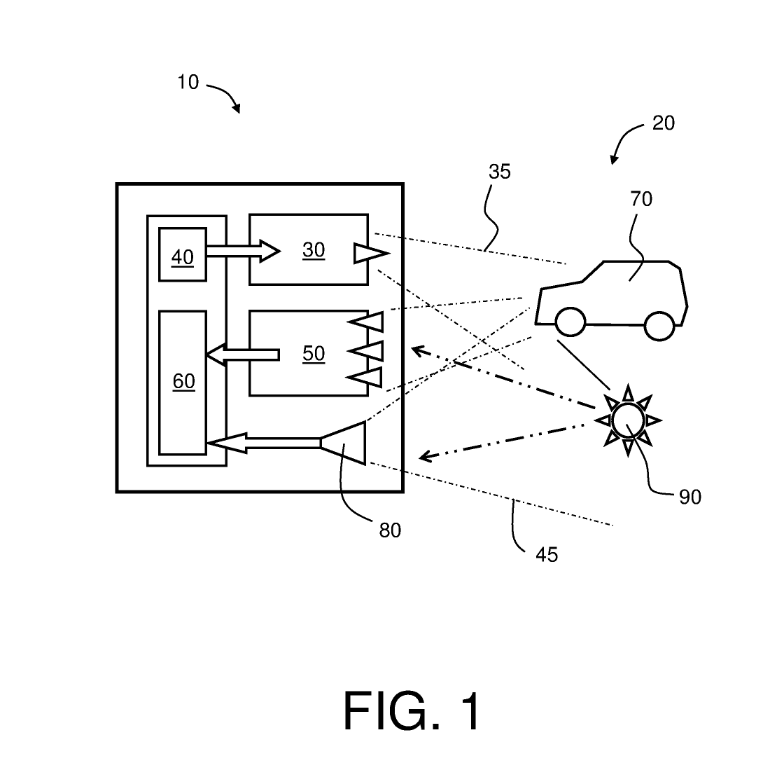

FIG. 1 is a schematic illustration of a radar system pursuant to the present disclosure, wherein the radar system utilizes an addition of an auxiliary channel when in operation; and

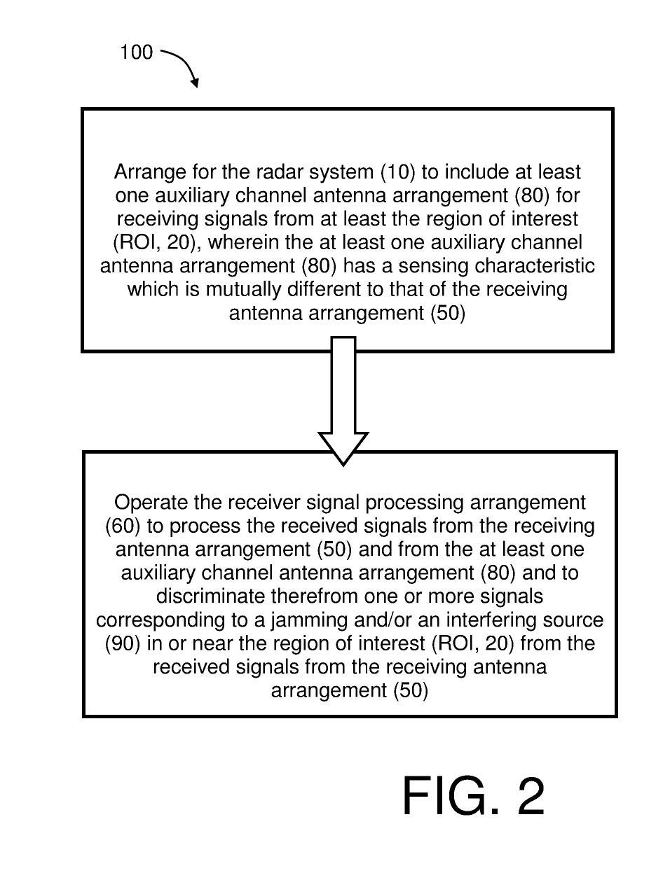

FIG. 2 is a flow chart of steps of a method of operating the radar system of FIG.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

According to a first aspect, there is provided a radar system for monitoring a region of interest (ROI), wherein the radar system includes a transmitter signal processing arrangement for generating signals for an emitting antenna arrangement to emit as electromagnetic radar radiation to the region of interest (ROI), wherein the transmitter signal processing arrangement is operable to employ frequency hopping in operation, and a receiving antenna arrangement for receiving reflected electromagnetic radar radiation from the region of interest (ROI) and a receiver signal processing arrangement for processing received signals corresponding to the reflected electromagnetic radar radiation from one or more objects in the region of interest (ROI), characterized in that:
(i) the radar system includes at least one auxiliary channel antenna arrangement for receiving signals from at least the region of interest (ROI), wherein the auxiliary channel antenna arrangement and the receiving antenna arrangement are mounted such that their axes are offset by an non-zero angle, and wherein the at least one auxiliary channel antenna arrangement has a sensing characteristic which is mutually different to that of the receiving antenna arrangement; and
(ii) the receiver signal processing arrangement is operable to process the received signals from the receiving antenna arrangement and from the at least one auxiliary channel antenna arrangement, and to discriminate therefrom one or more signals corresponding to a jamming and/or an interfering source in or near the region of interest (ROI) from the received signals from the receiving antenna arrangement.

The radar system is of advantage in that different relative responses of the receiving antenna arrangement and the at least one auxiliary channel antenna arrangement enables potentially interfering sources of radiation to be discriminated from reflected signals arising from objects within the region of interest (ROI).

Optionally, in the radar system, the transmitter signal processing arrangement, for generating signals to be emitted in operation as corresponding electromagnetic radar radiation from the emitting antenna arrangement, is operable to generate chirp signals when in operation. More optionally, in the radar system, the chirp signals, to be emitted in operation as corresponding electromagnetic radar radiation from the emitting antenna arrangement, are chirped in a range of 100 MHz to 500 MHz, and more optionally substantially 300 MHz.

More optionally, the radar system is operable to vary a centre frequency of the chirp signals. More optionally, the radar system is operable to vary the centre frequency of the chirp signals in at least one of following temporally-varying frequency patterns:
(a) a pre-determined manner;
(b) a frequency swept manner; and
(c) an adaptive manner, wherein the centre frequency is varied depending upon a degree of interference suppression exhibited by the radar system.

Optionally, in the radar system, the transmitter signal processing arrangement for generating signals to be emitted in operation as corresponding electromagnetic radar radiation from the emitting antenna arrangement is operable to employ temporally pseudo-random frequency hopping in operation.

Optionally, in the radar system, the emitting antenna arrangement is operable to emit the electromagnetic radar radiation in a range of 10 GHz to 200 GHz, and more optionally at substantially 24 GHz or substantially 77 GHz.

According to a second aspect, there is provided a method of using a radar system for monitoring a region of interest (ROI), wherein the radar system includes a transmitter signal processing arrangement for generating signals to be emitted in operation as corresponding electromagnetic radar radiation from an emitting antenna arrangement to the region of interest (ROI), wherein the transmitter signal processing arrangement is operable to employ frequency hopping in operation, and a receiving antenna arrangement for receiving reflected electromagnetic radar radiation from the region of interest (ROI) and a receiver signal processing arrangement for processing received signals corresponding to the reflected electromagnetic radar radiation from one or more objects in the region of interest (ROI), characterized in that the method includes:
(i) arranging for the radar system to include at least one auxiliary channel antenna arrangement for receiving signals from at least the region of interest (ROI), wherein the auxiliary channel antenna arrangement and the receiving antenna arrangement are mounted such that their axes are offset by an non-zero angle, and wherein the at least one auxiliary channel antenna arrangement has a sensing characteristic which is mutually different to that of the receiving antenna arrangement; and
(ii) operating the receiver signal processing arrangement to process the received signals from the receiving antenna arrangement and from the at least one auxiliary channel antenna arrangement and to discriminate therefrom one or more signals corresponding to a jamming and/or an interfering source in or near the region of interest (ROI) from the received signals from the receiving antenna arrangement.

Optionally, the method includes arranging for the transmitter signal processing arrangement for generating signals, to be emitted in operation as corresponding electromagnetic radar radiation from the emitting antenna arrangement, to be operable to generate chirp signal in operation. More optionally, the method includes arranging for the signals, to be emitted in operation as corresponding electromagnetic radar radiation from the emitting antenna arrangement, to be chirped in a range of 100 MHz to 500 MHz, and more optionally substantially 300 MHz.

Optionally, the method includes operating the radar system to vary a centre frequency of the chirp signals. More optionally, the method includes operating the radar system to vary the centre frequency of the chirp signals in at least one of following temporally-varying frequency patterns:
(a) a pre-determined manner;
(b) a frequency swept manner; and
(c) an adaptive manner, wherein the centre frequency is varied depending upon a degree of interference suppression exhibited by the radar system.

Optionally, the method includes arranging for the transmitter signal processing arrangement for generating signals, to be emitted in operation as corresponding electromagnetic radar radiation from the emitting antenna arrangement, to be operable to employ temporally pseudo-random frequency hopping in operation.

Optionally, he method includes arranging for the emitting antenna arrangement to be operable to emit the electromagnetic radar radiation in a range of 10 GHz to 200 GHz, and more optionally at substantially 24 GHz or substantially 77 GHz.

According to a third aspect, there is provided a method of using a radar system for monitoring a region of interest (ROI), wherein the radar system includes an emitting antenna arrangement for emitting electromagnetic radar radiation to the region of interest (ROI) and a transmitter signal processing arrangement for generating signals to be emitted in operation as corresponding electromagnetic radar radiation from the emitting antenna arrangement, and a receiving antenna arrangement for receiving reflected electromagnetic radar radiation from the region of interest (ROI), and a receiver signal processing arrangement for processing received signals corresponding to the reflected electromagnetic radar radiation from one or more objects in the region of interest (ROI), characterized in that the method includes:
(iii) arranging for the radar system to include at least one auxiliary channel antenna arrangement for receiving signals from at least the region of interest (ROI), wherein the at least one auxiliary channel antenna arrangement has a sensing characteristic which is mutually different to that of the receiving antenna arrangement; and
(iv) operating the receiver signal processing arrangement to process the received signals from the receiving antenna arrangement and from the at least one auxiliary channel antenna arrangement and to discriminate therefrom one or more signals corresponding to a jamming and/or an interfering source in or near the region of interest (ROI) from the received signals from the receiving antenna arrangement.

Optionally, the method includes arranging for the transmitter signal processing arrangement for generating signals, to be emitted in operation as corresponding electromagnetic radar radiation from the emitting antenna arrangement, to be operable to generate chirp signal in operation.

Optionally, the method includes arranging for the signals, to be emitted in operation as corresponding electromagnetic radar radiation, from the emitting antenna arrangement, to be chirped in a range of 1 MHz to 1000 Hz, more optionally in a range of 100 MHz to 500 MHz, and yet more optionally substantially 300 MHz.

Optionally, the method includes arranging for the transmitter signal processing arrangement for generating signals, to be emitted in operation as corresponding electromagnetic radar radiation from the emitting antenna arrangement, to be operable to employ temporally pseudo-random frequency hopping in operation.

Optionally, the method includes arranging for the emitting antenna arrangement to be operable to emit the electromagnetic radar radiation in a range of 10 GHz to 200 GHz and more optionally at substantially 24 GHz or substantially 77 GHz.

Optionally, the method includes monitoring one or more obstacles present within the region of interest (ROI), when the region of interest is a pedestrian crossing and/or a railway level-crossing environment.

According to a fourth aspect, there is provided a computer program product comprising a non-transitory computer-readable storage medium having computer-readable instructions stored thereon, the computer-readable instructions being executable by a computerized device comprising processing hardware to execute aforesaid methods of the disclosure.

In overview, referring to FIG. 1, embodiments of the present disclosure are concerned with a radar system, indicated by 10, for monitoring a region of interest (ROI) 20, for example a spatial region of the level crossing region of a railway network. The radar system 10 employs a method of detecting interferences in principal directions of operation of the radar system 10, for example in all spatial directions of operation of the radar system 10, via use of several continuous wave (CW) signals. The radar system 10 employs in operation an emitting antenna arrangement 30 for emitting electromagnetic radar radiation 35 to the region of interest (ROI) 20 and a transmitter signal processing arrangement 40 for generating signals to be emitted in operation as corresponding electromagnetic radar radiation 35 from the emitting antenna arrangement 30. The radar system 10 further employs in operation a receiving antenna arrangement 50 for receiving reflected electromagnetic radar radiation 45 from the region of interest (ROI) 20 and a receiver signal processing arrangement 60 for processing reflected radar signals corresponding to the reflected electromagnetic radar radiation 45, where the reflected electromagnetic radar radiation 45 results from reflections of the electromagnetic radar radiation 35 from one or more objects 70 in the region of interest (ROI) 20. In simpler terms, the radar system 10 is operable to employ the signals generated in operation by the transmitter signal processing arrangement 40 to generate electromagnetic radar radiation 35 to emit towards the region of interest (ROI) 20, and to receive the reflected electromagnetic radar radiation 45 from the region of interest (ROI) 20, wherein received signals corresponding to the reflected electromagnetic radar radiation 45 are processed to determine characteristics of one or more objects present in the region of interest (ROI) 20.

In addition to the emitting antenna arrangement 30 and the receiving antenna arrangement 50, the radar system 10 employs an auxiliary channel antenna arrangement 80 that is operable in an auxiliary channel, also known as a “guard channel” or a “passive guard channel”. Optionally, the auxiliary channel antenna arrangement 80 is operable in more than one auxiliary channel in the radar system 10. The auxiliary channel antenna arrangement 80 operates only in the receive mode and the provided channel has a low gain, wide beam width, namely wider than the channels of the emitting antenna arrangement 30 and the receiving antenna arrangement 50 of the radar system 10. Optionally, the auxiliary channel antenna arrangement 80 and the receiving antenna arrangement 50 are mounted so that their respective axes are offset by an non-zero angle, for example a non-zero angle greater than +/−5°, for example a non-zero angle greater than +/−10°. Optionally, the non-zero angle is dynamically varied depending upon conditions at a region of interest (ROI) 20 interrogated by the radar system 10, for example as a function of weather conditions, and/or in response to changing complexity of objects present in the region of interest (ROI) 20, for example 10 as function of traffic flow occurring in the region of interest (ROI) 20. In other words, the non-zero angle is varied in an adaptive manner in response to changing weather conditions, and/or in response to changing complexity of objects present in the region of interest (ROI) 20, for example 10 as function of traffic flow occurring in the region of interest (ROI) 20. Such an adaptive manner of changing the non-zero angle is based upon a numerical model hosted by a data processing arrangement, or controlled by a neural network adaptive learning network that is operable to seek a maximum in information content and/or to minimize jamming signals from the region of interest (ROI) 20 as a function of adaptively varying the non-zero angle. Consequently, when the axis of the receiving antenna arrangement 50 is in a horizontal direction, the axis of the auxiliary channel antenna arrangement 80 points, for example, toward the ground at the angle and leads the receiving antenna arrangement 50 by this angle as the antennas are scanned. It is assumed that the interfering signal from a jamming and/or interfering source, hereinafter simply referred to as the jamming source 90, present in the region of interest (ROI) 20; for example a vehicle with automatic brakes present at a level-crossing region, is located somewhere off the receiving antenna arrangement 50, such as in the side-lobes. On account of using such an implementation, the receiving antenna arrangement 50 may receive signals from both the one or more objects 70 and the interfering signals from the jamming source 90; however returns from the interfering signal in the receiving antenna arrangement 50 are weak because of the low side-lobe gain in the direction of the interfering signal. Moreover, it will be appreciated that the signals received by the auxiliary antenna arrangement 80 are primarily from the jamming source 90. In such manner, the auxiliary channel antenna arrangement 80 has a different sensitivity to the received signal, as compared to the receiving antenna arrangement 50, from the one or more objects 70 in the region of interest (ROI) 20, relative to a signal from the jamming source 90.

The receiver signal processing arrangement 60 is operable to process the received signals from the receiving antenna arrangement 50 and from the auxiliary channel antenna arrangement 80. As aforementioned, by varying the differential response of the received signals from the receiving antenna arrangement 50 and from the auxiliary channel antenna arrangement 80, the radar system 10 is operable to distinguish the jamming source 90 from the one or more objects 70 in the region of interest (ROI) 20. Moreover, the radar system 10 is operable to scan for determining a magnitude, frequency location and direction of the jamming source 90 present within the region of interest (ROI) 20. Using such information, in the radar system 10, the emitting antenna arrangement 30 is operable either to select suitable frequencies for the emitted electromagnetic radar radiation 35 to the region of interest (ROI) 20 and/or the receiver signal processing arrangement 60 is operable to employ interference suppression algorithms for processing received signals corresponding to the reflected electromagnetic radar radiation 45, to suppress the interference due to the jamming source 90 while interrogating the region of interest (ROI) 20 for the one or more objects 70.

In the radar system 10, the emitting antenna arrangement 30 is operable to emit the electromagnetic radar radiation 35 in a frequency range of 10 GHz to 200 GHz, and more optionally at substantially 24 GHz or substantially 77 GHz. In one example, the emitting antenna arrangement 30 employs an array of antenna elements, namely phased-array arrangement, for emitting the electromagnetic radar radiation 35 for interrogating the region of interest (ROI) 20. Furthermore, the receiving antenna arrangement 50 is operable to receive the reflected electromagnetic radar radiation 45 in a frequency range of 10 GHz to 200 GHz, and more optionally at substantially 24 GHz or substantially 77 GHz. In one example, the receiving antenna arrangement 50 also employs an array of antenna elements for receiving the reflected electromagnetic radar radiation 45 from the region of interest (ROI) 20. Optionally, the emitting antenna arrangement 30 and the receiving antenna arrangement 50 are directional antennas which radiate or receive greater power in specific directions allowing for increased performance and reduced interference from the one or more objects 70, and optionally use a broad beam width that allows for the signal to propagate reasonably well regardless of terrain. Optionally, a same array of antenna elements is employed both for the emitting antenna arrangement 30 and the receiving antenna arrangement 50; in other words, there is employed a transceiver antenna array. The transceiver antenna array is optionally electronically steered by varying in operation a phase and amplitude parameter of each antenna element of such a transceiver antenna array. Alternatively, the emitting antenna arrangement 30 and/or the receiving antenna arrangement 50 are mechanically-steered, for example mounted on rotatable mounts. Optionally, a hybrid combination of electronic and mechanical steering of the antenna arrangements 30, 50 is employed in operation.

Moreover, in the radar system 10, the transmitter signal processing arrangement 40 and the receiver signal processing arrangement 60 use one or more processors to implement signal processing functions, namely for generating the signals to be emitted as electromagnetic radar radiation 35 and processing the received signals corresponding to the reflected electromagnetic radar radiation 45. For example, the one or more processors are advantageously implemented as one or more reduced instruction set computers (RISC), or an array of such RISC's. The one or more processors are operable to execute one or more software products, including computer instructions, to control the operations of the radar system 10.

Optionally, the transmitter signal processing arrangement 40 is operable to employ chirp modulation to generate a chirped signal, also known as a sweep signal, to circumvent a situation arising in operation that the jamming source 90 present in the region of interest (ROI) 20 becomes aware of a manner of operation of the radar system 10. In one example, a chirp rate is dynamically changed to be different from that of the signals from the jamming source 90, for example by pseudo-randomly varying the chirp rate, for example the chirp rate is varied pursuant to a pre-defined pattern, like a linear chirp or an exponential chirp; such an approach is advantageous as it makes it very difficult for the jamming source 90 to interfere, for any extensive period of time, with operation of the radar system 10. More specifically, in frequency modulated continuous wave (FMCW) radar systems, there is typically employed chirp bandwidths of several 100 MHz, that are then, upon being emitted as the electromagnetic radar radiation 35 to the region of interest (ROI) 20 and then reflected therefrom as the reflected electromagnetic radar radiation 45, de-chirped with reference to a given signal employed to generate the electromagnetic radar radiation 35 down to baseband signals for subsequent processing in the radar system 10, for example for time-gating and/or correlation algorithms. Such chirp bandwidths of several 100 MHz are therefore, optionally, employed in operation of the radar system 10. Optionally, the transmitter signal processing arrangement 40 is operable to modulate the signals to generate the chirp signals in a range of 100 MHz to 500 MHz, and more optionally substantially 300 MHz. Yet alternatively, the radar system 10 is operable to employ narrower chirp bandwidths of less than 100 MHz, but dynamically vary a centre frequency of the chirps, for example in a pre-determined manner, in a repetitive manner, of in a frequency-swept manner as a function of time. Yet alternatively, the radar system 10 is operable to switch between employing wide-bandwidth chirps and narrow-bandwidth chirps, for example in chirping manner as aforementioned, to confuse interfering sources that are potentially present in operation in the region of interest (ROI) 20. Yet alternatively, a manner of chirping employed in the radar system 10 is adaptively changed as a function of being able to address interfering from the region of interest (ROI) 20, as a result of testing various chirping strategies and determining which of the chirping strategies provides a best suppression of interference from the region of interest (ROI) 20 when the radar system 10 is in operation.

Optionally, the transmitter signal processing arrangement 40 is operable to employ frequency hopping for the radar system 10 to avoid jamming at a specific frequency, such as the frequency corresponding to the jamming source 90. Optionally, the transmitter signal processing arrangement 40 is operable to employ temporally pseudo-random frequency hopping in operation. For example, the transmitter signal processing arrangement 40 is operable to employ a sequence of operating frequencies that are repeated after predefined intervals; such a repeated form of signal is beneficially correlated with the reflected electromagnetic radar radiation 45 from the region of interest (ROI) 20 during detection, to achieve an improved reliability of detection of one or more objects 70 in the region of interest (ROI) 20. The frequency steps employed between the individual continuous wave (CW) frequencies corresponds to a baseband bandwidth of the receiving antenna arrangement 50 and the receiver signal processing arrangement 60 of the radar system 10 for processing the received signal corresponding to the reflected electromagnetic radar radiation 45 from the region of interest (ROI) 20. Optionally, in the radar system 10, the transmitter signal processing arrangement 40 is operable to emit the electromagnetic radar radiation 35 as a plurality of continuous waves (CW) covering an instantaneous bandwidth of the radar waveform employed; such that it is feasible to process the received signal corresponding to the reflected electromagnetic radar radiation 45 to determine a spatial location, frequency range and emitting power of jamming source 90 present in operation within the region of interest (ROI) 20.

Referring to FIG. 2, there is shown a flow chart of steps of a method 100 of operating the radar system 10 for monitoring the region of interest (ROI) 20. The method 100 includes arranging for the radar system 10 to include the auxiliary channel antenna arrangement 80 for receiving signals from the region of interest (ROI) 20, wherein the auxiliary channel antenna arrangement 80 has a sensing characteristic that is mutually different to that of the receiving antenna arrangement 50. The method 100 further includes operating the receiver signal processing arrangement 60 to process the received signals from the receiving antenna arrangement 50 and from the auxiliary channel antenna arrangement 80, and to discriminate therefrom one or more signals corresponding to the jamming source 90 in or near the region of interest (ROI) 20 from the received signals from the receiving antenna arrangement 50. As described in the foregoing, the method 100 optionally includes employing chirped signals for use when radar-interrogating the region of interest (ROI) 20. Moreover, as described in the foregoing, the method 100 optionally includes employing varying angular orientation of the receiving antenna arrangement 50 relative to the receiving antenna arrangement 50 for assisting the radar system 10 to detect and suppress interfering radiation arising in operation from the region of interest (ROI) 20.

The radar system 10 is capable of being used in many fields of application, for example:
(i) for monitoring safety-critical areas, for example railway level-crossings;
(ii) for intruder alarm systems, for example for detecting unauthorized personnel;
(iii) for obstacle detection in automated agricultural equipment, for example automated combine harvesters, ploughing equipment, automated fruit picking apparatus;
(iv) for use on harbour (harbor; US English) facilities, for example for guiding automated equipment for handling ship containers;
(v) for on-vehicle radar systems, for example for automatic vehicle braking systems and/or automatic vehicle steering systems;
(vi) for airborne projectile guidance, for example high-velocity guided mortars; and so forth.

Modifications to embodiments of the present disclosure described in the foregoing are possible without departing from the scope of the invention as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A radar system (10) for monitoring a region of interest (ROI, 20), wherein the radar system (10) includes a transmitter signal processing arrangement (40) for generating signals for an emitting antenna arrangement (30) to emit as electromagnetic radar radiation (35) to the region of interest (ROI, 20), wherein the transmitter signal processing arrangement (40) is configured to employ frequency hopping in operation, and a receiving antenna arrangement (50) for receiving reflected electromagnetic radar radiation (45) from the region of interest (ROI, 20) and a receiver signal processing arrangement (60) for processing received signals corresponding to the reflected electromagnetic radar radiation (45) from one or more objects (70) in the region of interest (ROI, 20), wherein:
(i) the radar system (10) includes at least one auxiliary channel antenna arrangement (80) for receiving signals from at least the region of interest (ROI, 20), wherein the auxiliary channel antenna arrangement (80) and the receiving antenna arrangement (50) are mounted such that their axes are offset by an non-zero angle, and wherein the at least one auxiliary channel antenna arrangement (80) has a sensing characteristic which is mutually different to that of the receiving antenna arrangement (50); and
(ii) the receiver signal processing arrangement (60) is configured to process the received signals from the receiving antenna arrangement (50) and from the at least one auxiliary channel antenna arrangement (80), and to discriminate therefrom one or more signals corresponding to a jamming and/or an interfering source (90) in or near the region of interest (ROI, 20) from the received signals from the receiving antenna arrangement (50).

2. The radar system (10) as claimed in claim 1, wherein the transmitter signal processing arrangement (40), for generating signals to be emitted in operation as corresponding electromagnetic radar radiation (35) from the emitting antenna arrangement (30), is configured to generate chirp signals when in operation.

3. The radar system (10) as claimed in claim 2, wherein the chirp signals, to be emitted in operation as corresponding electromagnetic radar radiation (35) from the emitting antenna arrangement (30), are chirped in a range of 100 MHz to 500 MHz, and more optionally substantially 300 MHz.

4. The radar system (10) as claimed in claim 3, characterized wherein the radar system (10) is configured to vary a centre frequency of the chirp signals.

5. The radar system (10) as claimed in claim 4, wherein the radar system (10) is configured to vary the centre frequency of the chirp signals in at least one of following temporally-varying frequency patterns:
(a) a pre-determined manner;
(b) a frequency swept manner; and
(c) an adaptive manner, wherein the centre frequency is varied depending upon a degree of interference suppression exhibited by the radar system (10).

6. The radar system (10) as claimed in claim 1, wherein the transmitter signal processing arrangement (40) for generating signals to be emitted in operation as corresponding electromagnetic radar radiation (35) from the emitting antenna arrangement (30) is configured to employ temporally pseudo-random frequency hopping in operation.

7. The radar system (10) as claimed in claim 1, wherein the emitting antenna arrangement (30) is configured to emit the electromagnetic radar radiation (35) in a range of 10 GHz to 200 GHz, and more optionally at substantially 24 GHz or substantially 77 GHz.

8. A method (100) of using a radar system (10) for monitoring a region of interest (ROI, 20), wherein the radar system (10) includes a transmitter signal processing arrangement (40) for generating signals to be emitted in operation as corresponding electromagnetic radar radiation (35) from an emitting antenna arrangement (30) to the region of interest (ROI, 20), wherein the transmitter signal processing arrangement (40) is configured to employ frequency hopping in operation, and a receiving antenna arrangement (50) for receiving reflected electromagnetic radar radiation (45) from the region of interest (ROI, 20) and a receiver signal processing arrangement (60) for processing received signals corresponding to the reflected electromagnetic radar radiation (45) from one or more objects (70) in the region of interest (ROI, 20), wherein the method includes:
(i) arranging for the radar system (10) to include at least one auxiliary channel antenna arrangement (80) for receiving signals from at least the region of interest (ROI, 20), wherein the auxiliary channel antenna arrangement (80) and the receiving antenna arrangement (50) are mounted such that their axes are offset by an non-zero angle, and wherein the at least one auxiliary channel antenna arrangement (80) has a sensing characteristic which is mutually different to that of the receiving antenna arrangement (50); and
(ii) operating the receiver signal processing arrangement (60) to process the received signals from the receiving antenna arrangement (50) and from the at least one auxiliary channel antenna arrangement (80) and to discriminate therefrom one or more signals corresponding to a jamming and/or an interfering source (90) in or near the region of interest (ROI, 20) from the received signals from the receiving antenna arrangement (50).

9. The method (100) as claimed in claim 8, wherein the method (100) includes arranging for the transmitter signal processing arrangement (40) for generating signals, to be emitted in operation as corresponding electromagnetic radar radiation (35) from the emitting antenna arrangement (30), to be operable to generate chirp signal in operation.

10. The method (100) as claimed in claim 9, wherein the method (100) includes arranging for the signals, to be emitted in operation as corresponding electromagnetic radar radiation (35) from the emitting antenna arrangement (30), to be chirped in a range of 100 MHz to 500 MHz, and more optionally substantially 300 MHz.

11. The method as claimed in claim 10, wherein the method includes operating the radar system (10) to vary a centre frequency of the chirp signals.

12. The method as claimed in claim 11, wherein the method includes operating the radar system (10) to vary the centre frequency of the chirp signals in at least one of following temporally-varying frequency patterns:
(a) a pre-determined manner;
(b) a frequency swept manner; and
(c) an adaptive manner, wherein the centre frequency is varied depending upon a degree of interference suppression exhibited by the radar system (10).

13. The method (100) as claimed in claim 8, wherein the method (100) includes arranging for the transmitter signal processing arrangement (40) for generating signals, to be emitted in operation as corresponding electromagnetic radar radiation (35) from the emitting antenna arrangement (30), to be operable to employ temporally pseudo-random frequency hopping in operation.

14. The method (100) as claimed in claim 8, wherein the method (100) includes arranging for the emitting antenna arrangement (30) to be operable to emit the electromagnetic radar radiation (35) in a range of 10 GHz to 200 GHz, and more optionally at substantially 24 GHz or substantially 77 GHz.

15. A computer program product comprising a non-transitory computer-readable storage medium having computer-readable instructions stored thereon, the computer-readable instructions being executable by a computerized device comprising processing hardware to execute the method (100) as claimed in claim 8.
